(19) United States
(12) Patent Application Publication
(10) Pub. No.: US 2009/0278069 A1
(43) Pub. Date: Nov. 12, 2009

(54) Multiple piece frac valve insert

(76) Inventors: Ivan L. Blanco, Duncan, OK (US); Kenneth G. Neal, Duncan, OK (US)

Correspondence Address: JOHN W. WUSTENBERG, P.O. BOX 1431, DUNCAN, OK, 73536, US

(21) Appl. No.: 12/151,378

(22) Filed: May 6, 2008

(51) Int. Cl. F16K 5/00; F16K 1/42

(52) U.S. Cl. 251/309; 251/317; 251/361

(57) ABSTRACT

A multiple piece valve plug insert is disclosed. The valve plug insert has an insert body and an insert cover. The valve plug insert may be used with a valve having a valve seat and a valve plug that is movable into and out of sealing engagement with the valve seat. The valve plug insert along with a valve plug body comprise the valve plug.

### BACKGROUND

Positive displacement pumps, for example reciprocating pumps, are often used in oilfield operations to pump water, cement, fracturing fluids and other stimulation or treating fluids. Such pumps often endure harsh conditions, especially when pumping abrasive fluids. Valves and other components of such pumps are likewise exposed to harsh operating conditions. There is a continuing need for valves which will provide for longer efficient operation.

### SUMMARY

A multiple piece valve plug insert is disclosed. The valve plug insert may be used in a valve having a valve seat and a valve plug which is movable into and out of sealing engagement with the valve seat to prevent and allow fluid flow through a fluid passage therebetween. The valve plug may include a valve plug body with the valve plug insert affixed thereto. The valve plug insert is comprised of an insert body and an insert cover which overlies or covers at least a portion of an outer surface of the insert body.

The insert body is comprised of a first material and the insert cover is comprised of a second material. For example, the insert body may be comprised of a resilient material such as polyurethane and the insert cover may be comprised of a second material that is harder than the first material, such as for example polyethylene. The insert cover may overlie or cover a sufficient portion of the insert body such that only the insert cover is exposed to fluid flow while the insert body is protected therefrom. By preventing fluid from contacting the insert body, the resilient portion of the valve insert is protected from harsh chemicals and/or abrasives that may be included in the fluid that passes through a fluid passageway between the valve seat and the valve plug when the valve seat and valve plug are in a disengaged position.

### BRIEF DESCRIPTION OF THE DRAWINGS

FIG. 1 shows a perspective view of an insert plug of the present invention.

FIG. 2 shows a cross section of a valve in a closed position wherein the valve plug including the valve plug insert engages a valve seat.

FIG. 3 is a cross-sectional view of the valve in an open position.

FIG. 4 is a section view of a valve plug insert.

FIG. 5 is a cross-sectional view of a cylinder of a pump which may incorporate the valve utilizing the valve plug insert disclosed herein.

### DESCRIPTION OF A PREFERRED EMBODIMENT

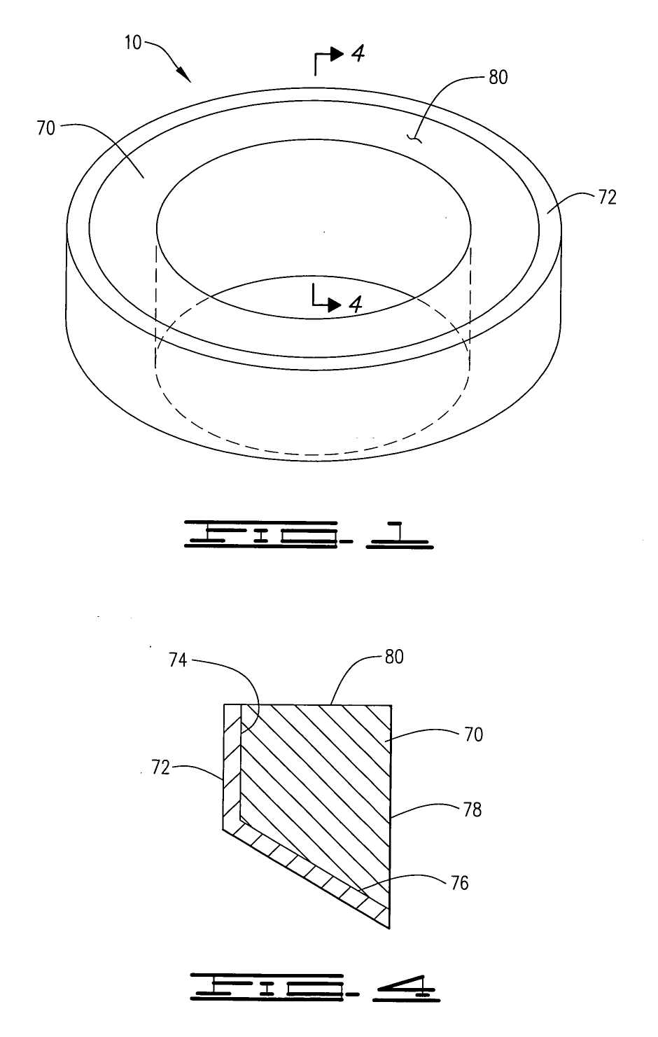

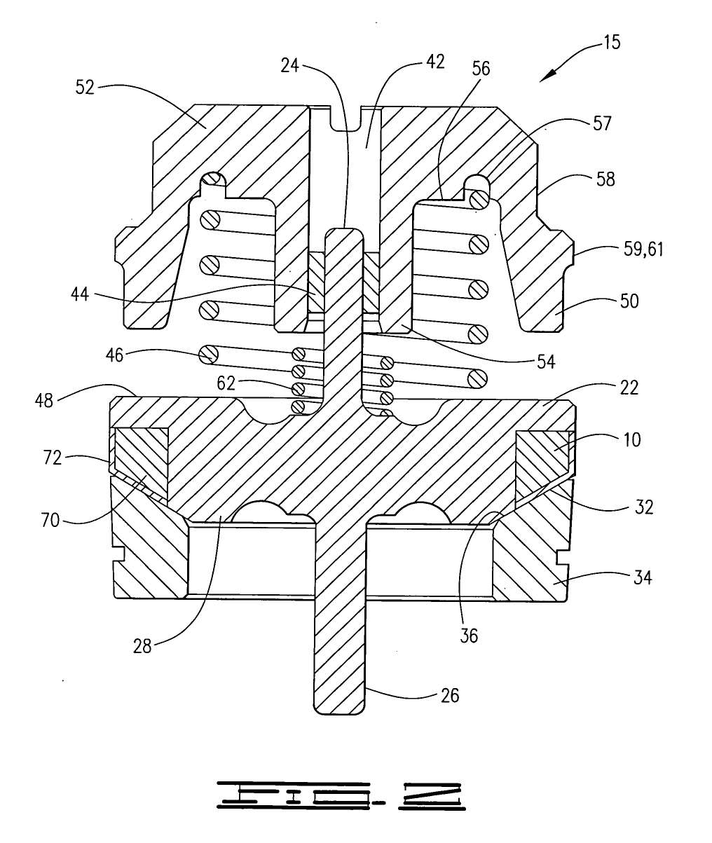

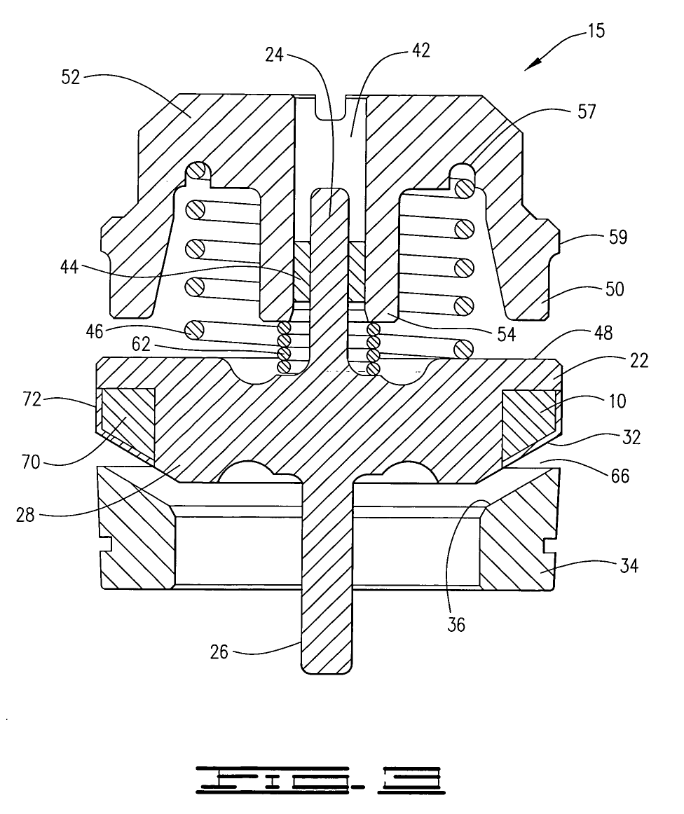

FIG. 1 is a perspective view of a valve plug insert 10 which may be used in a valve 15 such as valve 15 shown in FIG. 2, which may be a component part of a positive displacement pump. FIG. 5 is an illustration of a cylinder 20 of a positive displacement pump which may incorporate the valve 15 and valve plug insert 10. Referring now to FIGS. 2 and 3, valve 15 comprises a valve plug 22 which includes upper and lower valve stems 24 and 26, respectively. The valve stems extend upwardly and downwardly respectively from a valve plug body 28 which has valve plug insert 10 affixed thereto. Valve plug 22 defines a sealing surface 32, a portion of which is defined by a valve plug body 28 and another portion of which is defined by valve plug insert 10.

Valve 15 further comprises a valve seat 34 which defines a seating surface 36 that will sealingly engage sealing surface 32. A spring retainer 40 defines a central opening or central guide way 42 which will receive upper valve stem 24. Preferably, a bushing 44 is mounted in central guide way 42 and upper valve stem 24 is slidable therein.

A valve spring 46 which may be referred to as a first or main valve spring 46, acts upon an upper surface 48 of valve plug body 28 and will also act upon spring retainer 40. Spring retainer 40 may comprise a generally inverted U-shaped spring retainer 40 having an outer wall 50 and a top wall 52. A neck 54 extends from an inner surface 56 of top wall 52. Guide way 42 extends through neck 54. A notch 57 which will receive an end of spring 46 is defined in surface 56. The opposite end of spring 46 will engage upper surface 48.

Valve 15 may include a secondary spring 62 as described and disclosed in U.S. patent application Ser. No. 11/947,661 filed Nov. 29, 2007, and assigned to the assignee hereof, the details of which are incorporated herein by reference. The details of U.S. Pat. No. 5,226,445 also assigned to the assignee hereof and directed to a valve are likewise incorporated herein by reference. Outer wall 50 has first outer diameter 58 and second outer diameter 59 defining an engagement surface 61.

Referring now to the cylinder 20 shown in FIG. 5, a reciprocal piston 63 is disposed therein. Piston 63 will be driven with a motor or other means as is well known in the art. When reciprocal piston 63 is moved out of cylinder 20 on the suction stroke, low pressure is created within the cylinder 20 such that the pressure head at a suction inlet 64 overcomes the force of primary spring 46. Valve plug 22 will move away from seat 34 thereby creating a fluid passageway 66 therebetween.

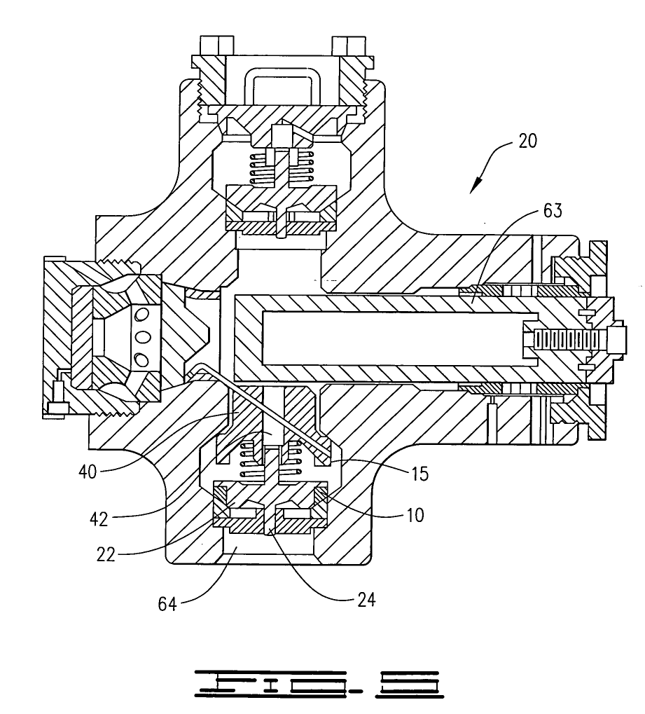

Referring now to FIG. 4, multi-piece valve plug insert 10 which is affixed to valve plug body 28 is preferably a two-piece valve plug insert comprising an insert body 70 and an insert cover 72. The valve plug insert has multiple sides as shown in cross section in FIG. 4, and cover 72 overlies or covers at least a portion of one side and preferably at least a portion of a plurality of the sides of plug insert body 70. In the section shown in FIG. 4, insert cover 72 covers two sides, namely, sides 74 and 76, but does not cover sides 78 and 80 of insert body 70. Insert body 70 is preferably made of a resilient material such as, for example, polyurethane. Insert cover 72 is preferably made from a second material which may be for example polyethylene which is not as resilient, but is harder than polyurethane.

When fluid is pulled through inlet 64 and passes through passageway 66, valve plug insert 10 is exposed to fluid flow which may have harsh chemicals and/or abrasives therein. In the embodiment described, insert cover 72 is exposed to the fluid flow and protects insert body 70 therefrom by preventing fluid from contacting insert body 70. Insert cover 72 may cover all of the plurality of sides of insert body 70 or only a portion of the sides thereof.

Sealing surface 32 on valve plug 22 is thus comprised of a portion of valve plug body 28 and a portion of valve plug insert 10 and thus is comprised at least in part of insert cover 72. During the discharge stroke of the piston 63, spring 46 will urge valve plug 22 into engagement with valve seat 34 so that sealing surface 32 engages seating surface 36. Plug cover 72 will sealingly engage the seating surface 36 as will a portion of plug body 28. Because insert cover 72 is the only portion exposed to abrasive and/or potentially chemically damaging fluids, valve plug insert 10 will be a longer lasting valve plug insert than those in the prior art which simply are comprised of resilient materials such as polyurethane with no cover. Such valve plug inserts while they work efficiently, have a shorter useful life than is desired due to the damaging nature of the fluid that flows through fluid passageway 66 when valve 15 is in its open or disengaged position in which fluid flows through fluid passageway 66. Valve plug 10, because it has a resilient portion (insert body 70) and a less resilient, harder portion (insert cover 72) will effectively seal, and will resist corrosion and erosion as compared to prior valve plug inserts which comprise only resilient materials. Although certain materials have been disclosed for insert body 70 and insert cover 72, it is understood that the disclosure is not limiting, and that other materials may be used. For example, material for insert cover 72 may not necessarily be a homogenous material and may comprise the same material as the material for body 70 reinforced with fabric so that the combination thereof comprises the second material, or may be a fiber-filled material.

Thus, it is seen that the apparatus and methods of the present invention readily achieve the ends and advantages mentioned as well as those inherent therein. While certain preferred embodiments of the invention have been illustrated and described for purposes of the present disclosure, numerous changes in the arrangement and construction of parts and steps may be made by those skilled in the art, which changes are encompassed within the scope and spirit of the present invention as defined by the appended claims. Accordingly, the scope of protection is not limited by the descriptions set forth above, but is defined by the claims that follow, that scope including all equivalents of the subject matter of the claims. Additionally, the headings used herein are provided for organizational purposes, and do not limit or characterize the invention set forth in the claims.

What is claimed is:

1. In a valve having a valve seat and a valve plug movable into and out of sealing engagement with the valve seat to prevent and allow fluid flow through a fluid passage therebetween, the valve plug comprising a valve plug body and a valve plug insert, the valve plug insert comprising:
an insert body comprised of a first material; and
an insert cover comprised of a second material secured to the insert body and covering at least a portion of an outer surface of the insert body.

2. The valve plug insert of claim 1 wherein the first material is a resilient material.

3. The valve plug insert of claim 1 wherein the first material is polyurethane and the second material is polyethylene.

4. The valve plug insert of claim 1, wherein the insert cover will prevent the insert body from being exposed to fluid flow when the valve plug is moved out of sealing engagement with the valve seat.

5. The valve plug insert of claim 1, wherein the valve plug defines a sealing surface for engaging and sealing with the valve seat, and wherein the sealing surface is defined at least partially by the valve plug insert.

6. The valve plug insert of claim 5 wherein the insert cover engages the valve seat when the valve plug is in sealing engagement with the valve seat.

7. A valve comprising:
a valve seat; and
a valve plug movable between an engaged position in which the valve plug engages the valve seat to prevent flow through a fluid passage therebetween past the valve seat and a disengaged position in which the valve plug is spaced from the valve seat to permit flow through the fluid passage past the valve plug, the valve plug comprising a valve plug body and a valve plug insert affixed to the valve plug body, wherein the valve plug insert comprises:
an insert body formed of a first material; and
an insert cover formed of a second material and covering at least a portion of the insert body.

8. The valve of claim 7, wherein the first material is polyurethane and the second material is polyethylene.

9. The valve of claim 8 wherein at least a portion of the insert cover engages the valve seat in the engaged position of the valve.

10. The valve of claim 7, wherein the insert cover is not exposed to fluid flow in the engaged or disengaged position of the valve plug.

11. The valve of claim 7, wherein the insert body has a polygonal cross section, and wherein the insert cover overlies at least a portion of each of two sides of the insert body.

12. A valve plug for use with a valve having a valve seat, wherein the valve plug is movable between engaged and disengaged positions with the valve seat to selectively prevent, or permit fluid flow past the valve seat, the valve plug having a valve plug body with a valve plug insert affixed thereto, the valve plug insert comprising:
an insert body made from a first material; and
an insert cover made from a second material affixed to the insert body and covering at least a portion of the insert body.

13. The valve plug of claim 12, wherein when the valve plug is in the engaged position, at least a portion of the insert cover is in contact with the valve seat.

14. The valve plug of claim 12, wherein the insert cover is the only portion of the valve plug insert exposed to fluid flow.

15. The valve plug of claim 12, wherein the first material is polyurethane and the second material is polyethylene.

16. The valve plug of claim 12, wherein the first material is more resilient than the second material.

17. A valve plug for use with a valve having a valve seat, the valve plug being movable between engaged and disengaged positions with the valve seat to prevent or permit fluid flow past the valve seat comprising:
a valve plug body; and
a multiple piece valve plug insert affixed to the valve plug body.

18. The valve plug of claim 17, the valve plug insert comprising an insert body and an insert cover affixed thereto.

19. The valve plug of claim 18, wherein the insert cover engages the valve seat in the engaged position.

20. The valve plug of claim 18, wherein the insert cover prevents fluid from contacting the insert body.

21. The valve plug of claim 18 wherein the insert cover is comprised of a first material and the insert body is comprised of a second material.

22. The valve plug of claim 21, wherein the insert cover is comprised of polyethylene.

23. The valve plug of claim 21, wherein the insert body is comprised of polyurethane.
